(19) United States
(12) Patent Application Publication
(10) Pub. No.: US 2003/0118191 A1
(43) Pub. Date: Jun. 26, 2003

(54) Mail Security method and system

(76) Inventors: Huayan Wang, Hauppauge, NY (US); Bruce A. Willins, East Northport, NY (US)

Correspondence Address: MARK I. KOFFSKY, SYMBOL TECHNOLOGIES, INC., ONE SYMBOL PLAZA, MS/A6, HOLTSVILLE, NY, 11742, US

(21) Appl. No.: 10/029,772

(22) Filed: Dec. 21, 2001

(51) Int. Cl. H04L 9/00

(52) U.S. Cl. 380/285; 713/176

(57) ABSTRACT

Described is a security envelope with a barcode carrying a digital signature signed by the sender or the first mailman at the entrance point of the postal system. This system imposes non-repudiation on the sender at its location or at its drop-off point. To provide authentication information, the barcode is scanned and tracked at each point from the source to the destination.

### REFERENCE TO RELATED APPLICATIONS

This application claims the benefit of U.S. Provisional Application Serial No. 60/ ______, filed Oct. 25, 2001, which is incorporated by reference herein in its entirety.

### BACKGROUND OF THE INVENTION

Our postal system singularly represents a readily available distribution network for bioterrorism. Estimates are that over 100 billion pieces of mail are delivered annually. The anthrax-laced mailings that occurred in the fall of 2001, reveal the lack of security in the system. In the current environment, the likelihood of anyone not receiving an item from a bulk mailing is small. In the United States alone, non-profit organizations send over 12 billion bulk mailings a year, producing an estimated response in donations of $50 billion.

People are scared of opening mail from unknown sources and even apparently known sources that cannot be authenticated. Postal service and mailroom workers are worried about their health and the inadequacy of the current tracking system makes investigation a complex and time-consuming, if not impossible, task. For example, in order to trace back an anthrax letter with a Trenton N.J. postmark, Federal officials in New Jersey interviewed postal workers and watched surveillance videotapes as part of their efforts to trace the letter. Postal Service officials believed it could have been mailed from one of 46 post offices, FBI Special Agent Sandra Carroll said. Carroll called it “a very complex and a very comprehensive investigation that's a lot like looking for a needle in a haystack.”

The object of the present invention is a solution to strengthen the security of the postal system using barcode (e.g. PDF417), barcode scanners and computer systems. The invention provides for indicia that validates and binds the authenticity of the sender, to physical attributes of the individual mail item itself. In a more secure embodiment of this invention, the physical attributes are virtually impossible to replicate and cannot be tampered with (e.g. remove and placed on another parcel) without detection.

### SUMMARY OF THE INVENTION

We propose to stamp the envelope with a barcode carrying a digital signature signed by the sender or the first mailman at the entrance point of the postal system. This system imposes non-repudiation on the sender at its location or at its drop-off point. The barcode is scanned and tracked at each point from the source to the destination. This way, mailroom clerks can scan incoming mail and take proper actions according to the source of the mail (verified by computer, rather than a simple print on the envelope, which can be forged). The tracking record can facilitate the investigation process. Thus, terrorists can be deterred if they know they can be exposed.

The system can be built incrementally. It can start with postal offices and large organizations to apply digital IDs (public/private key pair) from USPS and stamp their outgoing mail with proper information signed with a digital signature. The mail delivery and/or collection person can be equipped with a mobile wireless computer that can generate the above-mentioned barcode to be stamped on the envelopes. It can be gradually extended to small businesses and individuals. Eventually, everyone will have a digital postal ID (public/private key pair). The information contained in the bar code to identify the mail can start from simple text descriptions of the physical characteristics of the mail item (size, weight, other features), to pictures of the mail with emphasis on unique features, to truly unique, unforgeable physical structures, and/or combination of them. The proposed system can also be conveniently combined with e-stamp. It can also be incorporated into the postage meter machines rented or purchased by big corporations.

We propose to stamp the mail envelope with a bar code, such as a two-dimensional symbology PDF 417. The bar code, called a digital mail ID (DMID), contains useful identification information about the mailing. DMID includes a digital signature of the mail originator using their private key to ensure integrity, authenticity and non-repudiation. Optionally, confidentiality (encryption) can be used to provide stronger security check by the intended recipient to enhance trust.

For example, one can design the bar code content to have a public component which can be tracked by the postal system and a private component which can only be used by the intended recipient to verify the authenticity of the mail. DMID can comprise a combination of the following:

simple text description of the mail, such as the date, size, weight and other features,

a picture of the mail envelope, and

physical authentication identification.

The public component of the bar code content includes a subset of the DMID (e.g., the text description) and a digital signature (the public DMID hashed and encrypted using the sender's private key). If confidentiality is desired, the sender can also include a private component in the bar code with a more comprehensive set of DMID plus the digital signature, encrypted using the recipient's public key. This way, only the intended recipient having the proper private key can decode the private component. Then the recipient can verify the digital signature to ensure the integrity and authenticity of the DMID. Finally, the recipient can verify the authenticity of the mail by matching its DMID with the information coded in the bar code.

The above system thwarts threats by enforcing non-repudiation on the mail sender and verifying that the mail is never tampered during the delivery process. The former is achieved by having a digital signature signed by the sender, and the latter is achieved by matching the DMID encoded in the barcode with the actual mail.

A text description or a picture of the mail offer some level of identification but can be forged by carefully making a replica of the mailing with a copy of the identification barcode. For stronger security, it is desirable to have an unforgeable digital representation of the envelope (equivalent to the fingerprint of the envelope) as part of the digital mail ID. We call an ID with such characteristics the physical authentication ID. Today's technology can offer such physical authentications based on unique, random, identifiable physical structures.

One embodiment of such physical authentication ID is the physical one-way function proposed by Ravikanth Pappu of ThingMagic, which is based on the physics of coherent light transport through disordered micostructures (e.g., use optically clear epoxy with air bubbles suspended in it) See, Ravikanth Pappu, “Physical One-way Functions: Primitives for Physical Cryptograph”, MIT Ph.D Thesis. Another embodiment is the 3D structure authentication system (3DAS) proposed by van Renesse, which uses a piece of cloth made from non-woven 40 micron diameter polymer fibers. See van Renesse, R., “3DAS—a 3D structure authentication system”, Proceedings of the European Convention on Security and Detection, IEE, 1995. Other devices that can be used as the physical identification structure include those disclosed in Brosow, J., “Method and system for verifying authenticity safe against forgery”, U.S. Pat. No. 4,218,674; Goldman, R., “Verification system for document substance and content”, U.S. Pat. No. 4,568,936; Samyn, J., “Method and apparatus for checking the authenticity of documents”, U.S. Pat. No. 4,820,912; Denenberg, S., “System for registration, identification, and verification of items utilizing unique intrinsic features”, U.S. Pat. No. 5,521,984; U.S. Pat. No. 5,790,025 to Amer et al; and U.S. Pat. No. 5,354,097 to Tel. The disclosures of the foregoing cited articles and patents are incorporated herein by reference in their entirety.

The Brosow system uses magnetic fibers randomly sprinkled and embedded in a thin substrate. To read the identity of the token, a magnetic read head is passed along the substrate and the return signal is logically combined, using the AND operator with a clock sequence. This produces a digital signal that is the identifier. The Goldman patent teaches the use of variable translucency when a sheet of paper is illuminated with a light source. The data from the optical reader is logically combined with a clock to produce the identifier. The Samyn patent teaches small conducting particles embedded in an insulating substrate and uses microwaves to read the unique identifier. The Denenberg patent uses a video microscope to view a small area of a painting at several magnifications and correlates these images with previously stored images.

Still other techniques may include modified scanning devices to read and characterize speckle noise at registered locations on the mail item. Alternatively, scanning graphics for print artifacts that would be difficult to replicate with any other printer can be used.

Envelopes are created with the indicia as part of the physical structure of the envelope. They may be manufactured at the same time or added to the envelope afterward. To produce the digital signature of the envelope, the sender uses a scanner to scan the physical structure to produce a digital representation of the structure, which is transferred to a computer and used as the physical authentication ID. This information is then encoded into the DMID. At the destination, a computer verifies the digital signature of the sender to ensure authenticity, and the recipient scans the indicia to match the digital representation with the one encoded in the DMID bar code. According to Pappu, the process of manufacturing the physical structures is extremely simple and the scanner required to read the identifier can be a Symbol SE 1200 or 900 series scan engine and/or a CMOS imager. The same devices can be used to read the PDF417 bar code.

During the mail routing process, the mail can be tracked by scanning the bar code on the envelope and verified against the public digital signature using a computer (e.g., to prove its authenticity). Mailroom clerks and/or recipients can scan the barcode and be assured of the real source and take proper actions according to the trust level of the source. In case a letter needs to be traced back to the sender, the digital signature also offers non-repudiation and the sender cannot deny the action of signing the envelope.

### BRIEF DESCRIPTION OF THE DRAWINGS

FIG. 1 shows a secure envelope in accordance with the present invention;

FIG. 2 shows elements of a system for use in carrying out the methods according to the present invention;

FIG. 3 shows the structure of the digital mail identification of FIG. 1; and

FIG. 4 is a diagram of a method according to the present invention.

### DETAILED DESCPRIPTION OF THE INVENTION

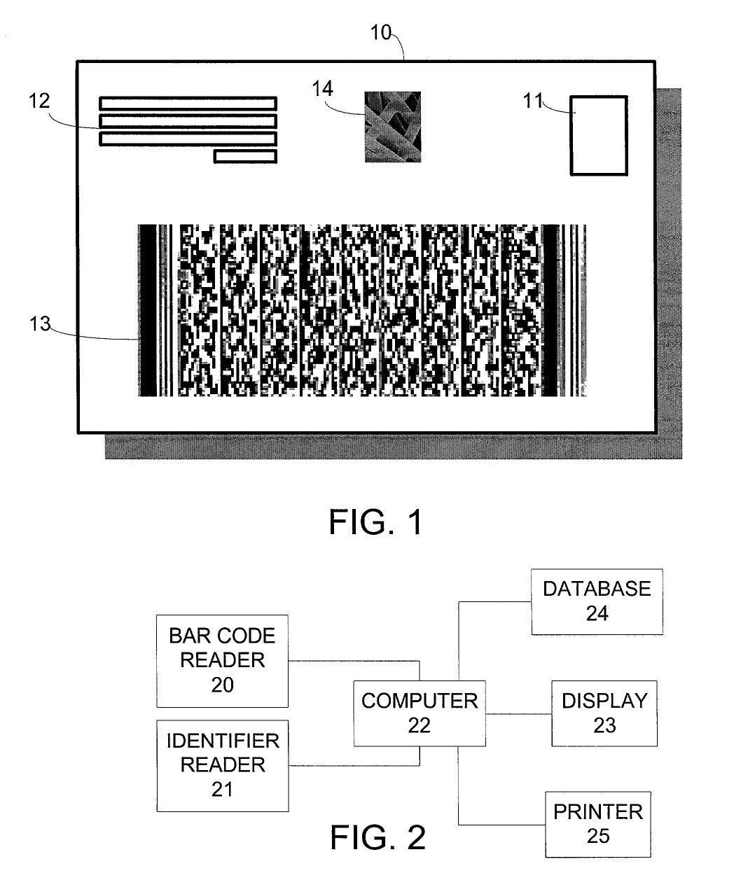

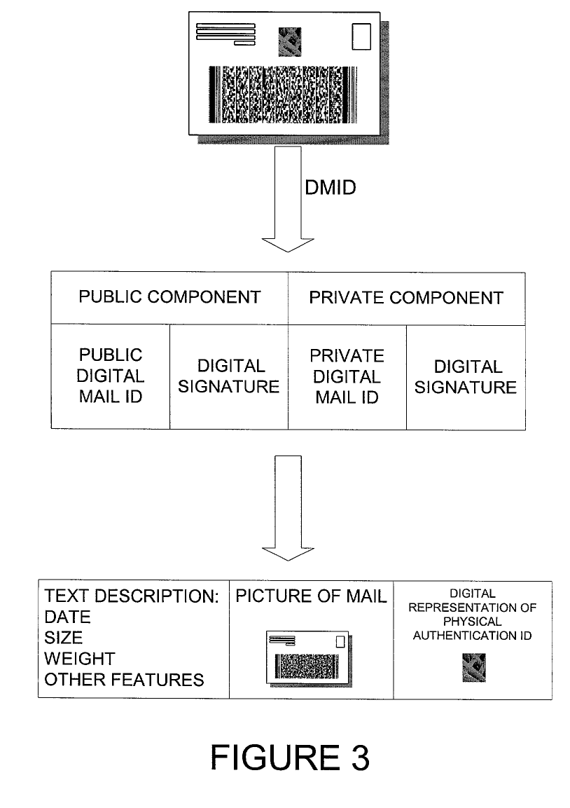

FIG. 1 illustrates a secure envelope in accordance with the present invention. The envelope 10 includes a return address 12, as well as postage 11, as is used with a conventional envelope. The envelope also includes a physical authentication ID 14, which is a unique identifier, which can be constructed as part of the physical structure of the envelope 10, or can be added on in a manner where removal thereof would result in its destruction and/or loss of unique coding. Examples of unique physical authentication ID structures are found in the aforementioned articles and patents, the disclosures of which are incorporated herein by reference.

The envelope 10 also includes a bar code 13, which is the digital mail identification (DMID) coding in accordance with the present invention. While the bar code 13 is shown in the position of the recipient address in FIG. 1, it is understood that the bar code 13 can be placed in an alternative location and that the recipient address can be placed in its normal location and printed in any conventional manner.

A bar code optical scanner may be freestanding or integrated into a mobile computer. Within this scanner, a light source, such as a laser, generates a light beam which is directed by optical components along a light path toward a bar code symbol. The laser light beam is repetitively scanned by a scanning component, such as an oscillating mirror situated in the beam path, to sweep a beam spot beam across the bar code symbol. A photodetector detects light of variable intensity reflected or scattered from the symbol and generates electrical signals indicative of the detected light. These electrical signals are decoded and into data representative of the data encoded in the symbol.

Moreover, it is understood that in accordance with the present invention, the DMID 13 can be in the location of return address 12 and can contain the return address information encoded therein. Alternatively, the DMID can be in the location of the stamp 11 and can contain postage in accordance with the e-stamp protocol. While the present invention is particularly useful in bulk mailing, it is understood that the system can be used with respect to individual mailings and with regard to parcels and other items sent through the mails or through courier services.

While the present invention is described for use with PDF417, it is understood that other two-dimensional bar codes and two-dimensional matrix codes can be used alternatively.

The DMID 13 can have a public component, a private component or both. The public component would have a public digital mail identification portion and use the digital signature of the sender. The private component would have private digital mail identification data and the digital signature of the sender.

The public digital mail identification data and the private digital mail identification data are preferably selected from: a text description, which can include the date of the mailing, the size of the envelope or parcel, the weight of the envelope or parcel and/or other features that can be used to describe the envelope and/or parcel; a digital picture of the mail; and the digital representation of the physical authentication ID. The public component preferably contains a subset of the DMID data, whereas the private component would preferably contain a complete set of that data.

FIG. 2 shows the elements of the system, which can be used to carry out the methods according to the present invention. The system components include a bar code reader 20 capable of reading the DMID in PDF417 form or in the form of other two-dimensional bar codes and/or matrix codes. The physical authentication identifier reader 21 is able to read the physical authentication ID 14. By using certain two-dimensional imaging technology and/or two-dimensional laser scanning technology, the same reader can be used for reading both the DMID 13 and the physical authentication ID 14. The output of the readers 20 and 21 are fed to a computer 22, which can decode the data, or if the data is already decoded by the readers 20 and 21, receive the data and compare the data read from the two in order to authenticate the mail. The computer 22 works with the database 24, which has the public key and/or private key information for a particular sender stored therein, so that the digital signature of the sender can be authenticated. The computer 22 also interfaces with a printer 25 for printing the DMID labels or printing the DMID bar code directly onto an envelope. The computer 22 further operates with display 23 for displaying the information read by readers 20 and 21, so that the picture of the mailing and/or the text description of the mailing can be compared to the mailing itself. The computer can be a handheld integrated computer, preferably wireless, such as a Symbol PDT8100, PPT2800, SPS3000 and SPT1700 and appropriate accessories.

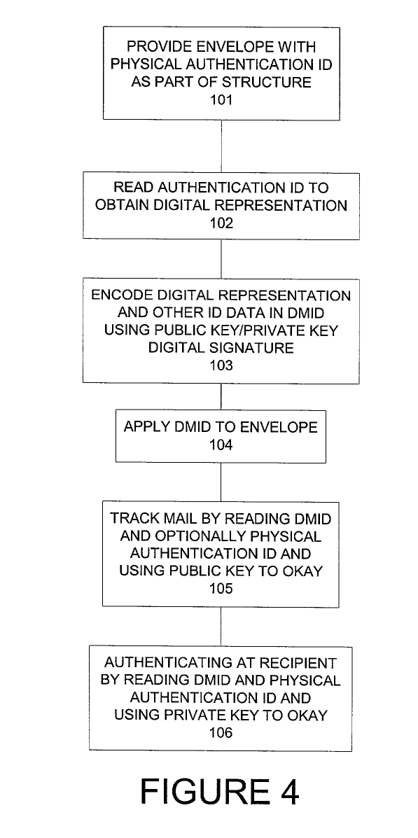

FIG. 4 shows a block diagram of the method in accordance with the present invention. In step 101, an envelope 10 is provided with the physical authentication ID 14 as part of the structure of the envelope. Alternatively, the physical authentication ID 14 can be added on to the envelope. The sender would have a system similar to the system shown in FIG. 2, including the physical authentication ID reader 21, the computer 22 and the printer 25. The sender would read the authentication ID to obtain the digital representation thereof in step 102 and would encode the digital representation and other ID data in the DMID using a public key/private key digital signature in step 103. The computer can use the printer 25 to either print the DMID directly on the envelope, or on a label which is attached to the envelope. The system for the user as thus described, can be in a fixed location or can be incorporated into a handheld terminal which can communicate with a network, such as a local area network, using wireless protocols, such as IEEE 802.11, IEEE 802.11a, IEEE 802.11b, Bluetooth, etc.

The mail is then either brought to the post office, placed in a mailbox or handed to a postal worker. Each postal employee, or at least one postal employee, in each step of handling the mail by the post office, can be equipped with a system including the readers 20 and 21, computer 22, database 24 and display 23. Each of these elements can be in a fixed configuration or can be part of a handheld mobile computer in the form of an integrated terminal, which can be connected to a local area network or other network via cable or through wireless protocol, such as the one hereinafter identified. Each postal worker would track the mail in step 105 by reading the DMID and optionally the physical authentication ID and use the public key to authenticate the mail.

Data gathered by the mobile computer may be stored and transmitted at a later point to other parts of a network (batch mode) or transferred to the network soon after acquisition using a pre-installed wireless network. The assignee of the present invention supplies a wireless data communications systems known as the Spectrum 24® System, which follows the communications protocol of IEEE Standard 802.11. In the system as implemented, mobile units are in data communication with a central computer through access points. The access points communicate with the computer over an Ethernet wired network. The transmission data and the reception data may use a TCP/IP protocol, and the wired network may also be connected to the Internet. Each of the mobile units associates itself with one of the access points. In order to maintain order and reduce radio communications each access point must determine which of the communications received over the Ethernet link from the central computer is destined for a mobile unit associated with that particular access point.

The recipient in step 106 would finally authenticate the mail by having a system similar to the one shown in FIG. 2, reading the DMID and physical authentication ID and using the private key to check the digital signature and compare the data describing the envelope to the envelope itself.

It is understood that the embodiments described hereinabove are merely illustrative and are not intended to limit the scope of the invention. It is realized that various changes, alterations, rearrangements and modifications can be made by those skilled in the art without substantially departing from the spirit and scope of the present invention.

We claim:

1. A security envelope, comprising:
a barcode in a two-dimensional symbology located on the security envelope, the barcode encoding:
a public component, the public component comprising a public digital mail identification and a digital signature signed by the sender encrypted by the private key of the sender; and
a private component, the private component comprising a private digital mail identification and a digital signature signed by the sender encrypted by the public key of the receiver.

2. The security envelope as in claim 1, where the two-dimensional symbology is PDF-417.

3. The security envelope as in claim 2, wherein the barcode further encodes return address information.

4. The security envelope as in claim 2, wherein the barcode further encodes information relating to the physical characteristics of the security envelope.

5 The security envelope as in claim 4, wherein the information relating to the physical characteristics of the security envelope include at least one of: (a) the date the security envelope was sealed; (b) the size of the security envelope; and (c) the weight of the security envelope.

6. The security envelope as in claim 2, wherein the barcode further encodes stamp information.

7. The security envelope as in claim 2, wherein the security envelope further comprises a physical authentication identification and wherein the barcode further comprises a digital representation of the physical authentication identification.

8. The security envelope as in claim 7, where the physical authentication identification comprises an optically clear epoxy with air bubbles suspended therein.

9. The security envelope as in claim 7, where the physical authentication identification comprises a cloth made from non-woven 40 micron diameter polymer fibers.

10. A method for securing the mails, comprising:
(1) producing a digital mail identification that encodes physical identification information of a security envelope into a barcode in a two-dimensional symbology; wherein the digital mail identification comprises:
(a) a public component, the public component comprising a public digital mail identification and a digital signature signed by the sender encrypted by the private key of the sender; and
(b) a private component, the private component comprising a private digital mail identification and a digital signature signed by the sender encrypted by the public key of the receiver;
(2) applying the digital mail identification to the security envelope.

11. The method as in claim 10, where the two-dimensional symbology is PDF-417.

12. The method as in claim 11, wherein the physical identification information comprises return address information.

13. The method as in claim 11, wherein the physical identification information comprises information relating to the physical characteristics of the security envelope.

14 The method as in claim 13, wherein the information relating to the physical characteristics of the security envelope include at least one of: (a) the date the security envelope was sealed; (b) the size of the security envelope; and (c) the weight of the security envelope.

15. The method as in claim 11, wherein the physical identification information comprises stamp information.

16. The method as in claim 11, where the physical identification information comprises an optically clear epoxy with air bubbles suspended therein.

17. The method as in claim 11, where the physical identification information comprises a cloth made from non-woven 40 micron diameter polymer fibers.

18. The method as in claim 11, further comprising:
measuring the physical identification information;
decoding the digital mail identification;
comparing the measured physical identification information with the decoded digital mail identification.

19. The method as in claim 18, wherein at least one of the steps of (1) measuring the physical identification information, and (2) decoding the digital mail identification is accomplished using an optical scanner.

20. The method as in claim 19, wherein the step of comparing the measured physical identification information with the decoded digital mail identification is accomplished using a mobile computer.

21. The method as in claim 19, further comprising:
transmitting the measured physical identification information and the decoded digital mail identification to a wired computer network via a wireless medium.

22. The method as in claim 21, wherein the wired computer network is connected to the Internet and the transmitting the identification data to a wired computer network via a wireless medium uses a TCP/IP protocol.

23. A system of securing the mails, comprising:
(1) at least one security envelope, comprising
(a) a barcode in a two-dimensional symbology located on the security envelope, the barcode encoding:
(i) a public component, the public component comprising a public digital mail identification and a digital signature signed by the sender encrypted by the private key of the sender; and
(ii) a private component, the private component comprising a private digital mail identification and a digital signature signed by the sender encrypted by the public key of the receiver;
(2) at least one mobile computer, comprising:
(a) a bar code reader;
(b) a physical authentication identifier reader;
(c) a computer capable of comparing information obtained from the bar code reader and the physical authentication identifier reader;
(d) a database capable of storing at least one public key and at least one private key;
(e) a display; and
(f) a printer.

24. The system as in claim 23, where the two-dimensional symbology is PDF-417.

25. The system as in claim 24, where the at least one security envelope further comprises an optically clear epoxy with air bubbles suspended therein.

26. The system as in claim 24, where the at least one security envelope further comprises a cloth made from non-woven 40 micron diameter polymer fibers.

27. The system as in claim 24, further comprising:
a wired computer network capable of communication with the at least one mobile computers via a wireless medium.

28. The system as in claim 27, wherein the wired computer network is connected to the Internet using a TCP/IP protocol.
